(19) United States
(12) Patent Application Publication
(10) Pub. No.: US 2012/0118606 A1
(43) Pub. Date: May 17, 2012

(54) CONDUCTIVE FILM AND MANUFACTURING METHOD THEREOF

(75) Inventors: Jae Il Kim, Gyunggi-do (KR); Woon Chun Kim, Gyunggi-do (KR); Yong Soo Oh, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 13/082,669

(22) Filed: Apr. 8, 2011

(30) Foreign Application Priority Data
Nov. 11, 2010 (KR) 1020100112284

(51) Int. Cl. H01B 5/00; B32B 38/14; B32B 38/04; B32B 37/02

(52) U.S. Cl. 174/126.1; 156/253

(57) ABSTRACT

Disclosed herein are conductive film including: a base member; N transparent electrodes formed on one surface of the base member, the N transparent electrodes being arranged in a second direction of the base member, while being extended in a first direction of the base member; and electrode wirings each correspondingly connected to one end or both ends of the N transparent electrodes and including wiring portions configured of a plurality of wirings extended in a third direction of the base member and bent and extended in the second direction of the base member and insulating portions having the wiring portions impregnated therein and formed on an upper surface of one side or both sides of the transparent electrode and a manufacturing method thereof. Accordingly, the plurality of wirings are formed in a three-dimensional shape vertically in the insulating portion rather than a plane of the base member, making it possible to reduce the area of a non-display region due to the electrode wirings.

### CROSS REFERENCE TO RELATED APPLICATION

This application claims the benefit of Korean Patent Application No. 10-2010-0112284, filed on Nov. 11, 2010, entitled “CONDUCTIVE FILM AND MANUFACTURING METHOD THEREOF”, which is hereby incorporated by reference in its entirety into this application.

### BACKGROUND OF THE INVENTION

1. Technical Field

The present invention relates to a conductive film and a manufacturing method thereof.

2. Description of the Related Art

As computers using digital technology are grown, devices assisting computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse as being currently responsible for the input device function. Thus, the demand for a device that is simple, has minimum malfunction, and has the capability to easily input information is increasing.

Furthermore, current techniques for input devices exceed the level of fulfilling general functions and are progressing towards high reliability, durability, innovation, designing and manufacturing related techniques. To this end, a touch panel has been developed as an input device capable of inputting information such as text and graphics.

The touch panel is mounted on the display surface of an image display device such as an electronic organizer, a flat panel display including a liquid crystal display (LCD) device, a plasma display panel (PDP), an electroluminescence (El) element, or the like, and a cathode ray tube (CRT), such that a user selects the desired information while viewing the image display device.

The touch panel is classifiable as a resistive type, a capacitive type, an electromagnetic type, a surface acoustic wave (SAW) type, and an infrared type. These various types of touch panels are adapted for an electronic product in consideration of signal amplification problems, resolution differences, the degree of difficulty of designing and manufacturing technology, optical characteristics, electrical characteristics, mechanical characteristics, resistance to the environment, input properties, durability and economic benefits. The resistive type of touch panel and the capacitive type of touch pane are currently used in a broad range of fields.

The resistive type of touch panel has a form in which upper/lower transparent electrode films are disposed to be spaced by a spacer and be contacted to each other by pressure. In the resistive type of touch panel, when an upper conductive film formed with the upper transparent electrode film is pressed by an input unit such as fingers, pens, or the like, the upper/lower transparent electrode films are conducted and a change in voltage according to a change in resistance value in the position is recognized by a controller, such that the touched coordinates are recognized. As the resistive type of touch panel, there are a digital resistive type of touch panel and an analog resistive type of touch panel.

The capacitive type of touch pane has a form in which an upper conductive film (not shown) formed with a first transparent electrode (not shown) and a lower conductive film formed with a second transparent electrode 120 are spaced from each other and an insulator is inserted between the first and second transparent electrodes so that the first transparent electrode and the second transparent electrode 120 are not contacted to each other, as shown in FIG. 1. In addition, the upper and lower conductive films are formed with electrode wirings 130 connected to the second transparent electrode 120.

The electrode wirings 130 have an input unit contacted to a touch screen to transfer a change in capacitance generated in the first transparent electrode and the second transparent electrode 120 to a controller.

The touch panel may be divided into a display region (R1) through which an image generated in an image display device passes when the image display device is coupled to an lower portion of the touch panel and a non-display region (R2) that encompasses the circumference of to the display region (R1) and through which the image does not pass.

The display region (R1) is formed with the second transparent electrode 120. The display region R1 is a region in which when a user touches thereto, a touched coordinate is detected. The non-display region (R2) is formed with the electrode wirings 130, and is not generally known in the outside in use. Meanwhile, the electrode wiring 130 formed in the non-display region (R2) is an important element determining an area of the non-display region (R2). The capacitive type of touch panel has a problem in that when a plurality of electrode wirings each connected to a plurality of transparent electrodes are formed on a plane of a base member, the area of the non-display region (R2) becomes large due to predetermined wiring intervals between the electrode wirings. Accordingly, the area of the display region (R1) is relatively reduced, thereby having a difficulty in miniaturizing the touch panel.

### SUMMARY OF THE INVENTION

The present invention has been made in an effort to provide a conductive film capable reducing the area of a non-display region due to electrode wirings by forming electrode wirings as a multi-layer on a plane perpendicular to base member to have a three-dimensional shape and a manufacturing method thereof.

A conductive film according to a first preferred embodiment of the present invention includes: a base member; N transparent electrodes formed on one surface of the base member, the N transparent electrodes arranged in a second direction of the base member, while being extended in a first direction of the base member; and electrode wirings each correspondingly connected to one end or both ends of the N transparent electrodes and including wiring portions configured of a plurality of wirings extended in a third direction of the base member and bent and extended in the second direction of the base member and insulating portions having the wiring portions to impregnated therein and formed on an upper surface of one side or both sides of the transparent electrode.

The wiring portions may be extended to be shorter in a third direction of the base member according to the order thereof connected to the transparent electrodes formed from a lower side of the base member to an upper side thereof and are bent and extended in the second direction of the base member.

The wiring portions may be formed on the same perpendicular plane to the base member.

The transparent electrode may be made of a conductive polymer.

The conductive polymer may be any one of polythiophene-based compound, polypyrrole-based compound, polyphenylene-based compound, polyaniline-based compound or polyacetylene-based compound.

The electrode wiring may be made of silver (Ag).

A manufacturing method of a conductive film according to a second preferred embodiment of the present invention includes: (A) forming N transparent electrodes on a base member, the N transparent electrode being arranged in a second direction of the base member, while being extended in a first direction of the base member; (B) stacking insulating layers extended in the second direction of the base member on an upper portion of one end or both ends of the transparent electrodes; (C) forming through-holes in the insulating layers so that one of the N transparent electrodes is exposed; and (D) forming wirings extended in the second direction of the base member on upper portions of the insulating layers to be electrically connected to the exposed transparent electrode, wherein step (B), step (C), and step (D) are repetitively performed and the through-holes are sequentially formed from a lower side of the base member to an upper side thereof.

The manufacturing method of a conductive film may further include, after repetitively performing step (B), step (C), and step (D), (E) forming a protective layer covering the wiring formed on a top portion of the insulating layer.

In repetitively performing step (B), the through-holes may be sequentially formed in a straight line.

Step (D) may include: (D-1) filling the through-holes with the conductive paste; and (D-2) forming metal patterns electrically connected to the conductive paste and extended in the second direction of the base member.

The metal patterns may be formed using any one of a silk screen method, a gravure printing method or an inkjet printing method.

### BRIEF DESCRIPTION OF THE DRAWINGS

FIG. 1 is a plan view showing a conductive film of a capacitive type of touch panel according to the related art;

FIG. 2 is a plan view of a capacitive type of touch panel according to a preferred embodiment of the present invention;

FIG. 3 is a cross-sectional view of electrode wirings according to a preferred embodiment of the present invention;

FIG. 4 is a perspective view of electrode wirings according to a preferred embodiment of the present invention; and

FIGS. 5 to 12 are plan and cross-sectional views showing a manufacturing process of a conductive film according to a preferred embodiment of the present invention.

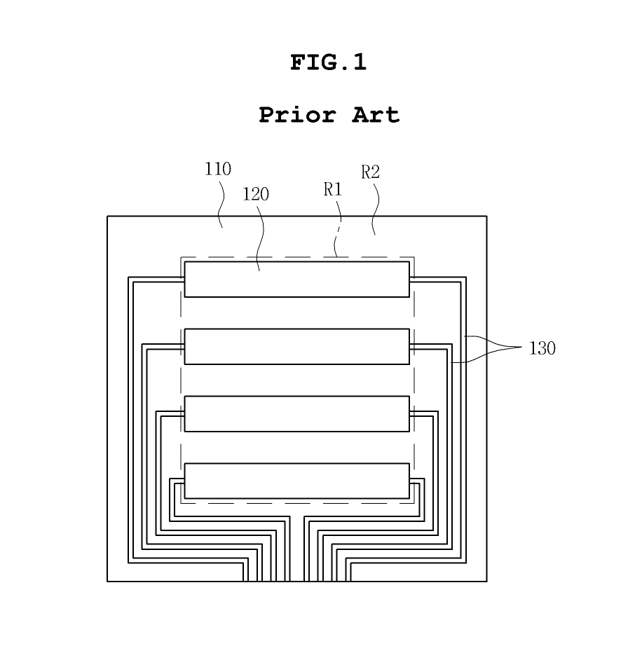

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

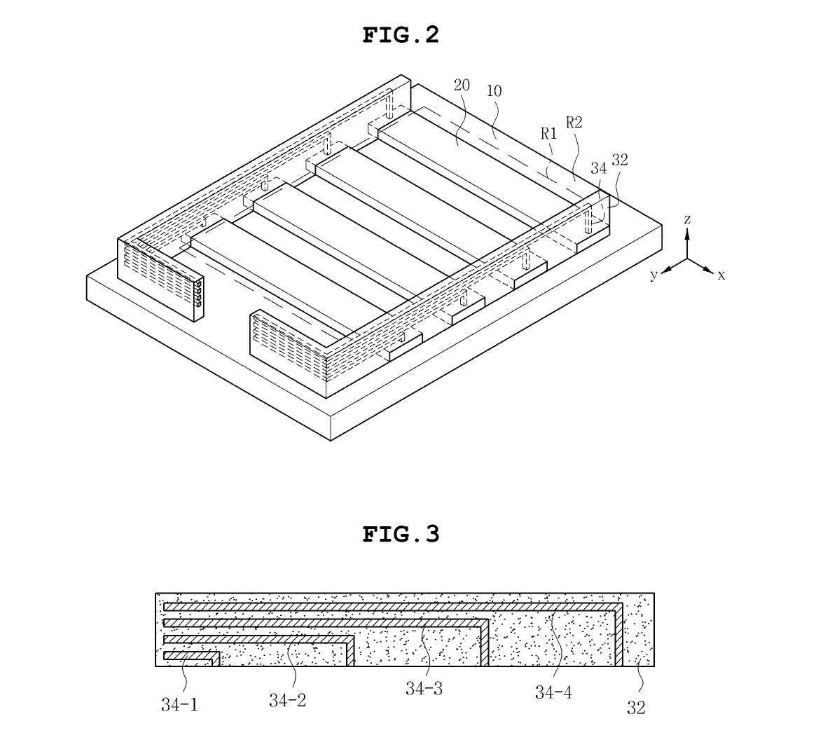

In a following detailed description, ‘first direction’ indicates an X-axis direction as shown as a coordinate in an upper end of FIG. 2. Further, ‘second direction’ indicates a Y-axis direction and is not limited to a direction perpendicular to the ‘first direction’. In addition, ‘third direction’ indicates a Z-axis direction and is not limited to a direction perpendicular to the ‘first direction’ and the ‘second direction’.

Hereinafter, preferred embodiments of the present invention will be described in detail with reference to the accompanying drawings.

FIG. 2 is a plan view of a conductive film of a capacitive type of touch panel according to a preferred embodiment of the present invention; Hereinafter, a conductive film of a capacitive type of touch screen according to a preferred embodiment of the present invention will be described with reference to FIG. 2.

The conductive film is configured to include a base member 10, and transparent electrodes 20 and electrode wirings 30 formed on the base member 10. The transparent electrodes 20 are formed in a display region (R1) and the electrode wirings are formed in a non-display region (R2).

N transparent electrodes 20 are formed on one surface of the base member 10, the N transparent electrode being arranged in a second direction of the base member 10, while being extended in a first direction of the base member 10, as shown in FIG. 2. The transparent electrode 20 is a portion sensing a change in capacitance when a user's hand touches a touch screen. As shown in FIG. 2, the N transparent electrodes are arranged at predetermined intervals in the same shape, thereby allowing the controller to accurately recognize the touch point of the user. In addition, the transparent electrodes 20 extended in the first direction of the base member 10 may also be configured of a plurality of sensor regions and connecting regions connecting adjacent sensor regions. The sensor region may have a rectangular shape, a diamond shape, or a circular shape. However, the shape of the sensor region is only one example and is not limited thereto.

The transparent electrodes 20 are made of a transparent conductive material. As a material composing the transparent electrode 20, a transparent conductive oxide (TCO) such as an indium tin oxide (ITO), an antimony tin oxide (ATO), and the like is generally used.

At this time, the material composing the transparent electrode 20, preferably, may be a conductive polymer. The conductive polymer has an excellent flexibility and a simple coating process. As the conductive polymer, an organic compound, such as polythiophene-based compound, polypyrrole-based compound, polyaniline-based compound, polyacetylene-based compound, polyphenylene-based compound, or the like may be used. In particular, among the polyth iophene-based compound, poly-3,4-ethylenedioxythiophene/polystyrenesulfonate (PEDOT/PSS) compound is most preferable and at least one mixture of the organic compounds may be used.

The electrode wirings 30 are configured of wiring portions 34 and insulating portions 32. Each of the wiring portions 34 is correspondingly connected to one ends or both ends of the N transparent electrodes 20, is configured as a wiring extended in a third direction of the base member 10 and bent and extended in the second direction of the base member 10. The insulating portions 32 are impregnated with the wiring portions 34 and are formed on an upper portion of one side or both sides of the base member 10.

The wiring portions 34 are extended in different lengths in the third direction of the base member 10 and are bent and extended in the second direction of the base member 10, such that a plurality of wirings are formed as a multi-layer on a plane perpendicular to the base member. Unlike a configuration of the relate art in which a plurality of electrode wirings 30 are formed on the plane of the base member 10, the electrode wirings 30 are disposed to charge predetermined spaces in the third direction of the base member 10, thereby making it possible to reduce the area of the non-display region (R2) on the plane of the base member 10.

At this time, as shown in FIG. 3, the wiring portions 34 are extended to be shorter in the third direction of the base member 10 according to the order thereof connected to the transparent electrodes formed from a lower side of the base member 10 to an upper side thereof and are bent and extended in the second direction of the base member 10. In FIG. 3, a first wiring 34-1 connected to the transparent electrode 20 formed at the lowermost side of the base member 10 has the shortest length extended in the third direction of the base member 10 and is bent and extended in the second direction of the base member 10. Next, a second wiring 34-2 connected to an upper side transparent electrode 20 adjacent to the transparent electrode 20 formed at the lowermost side of the base member 10 is extended to be longer than the first wiring 34-1 in the third direction of the base member 10 and is bent and extended in the second direction of the base member 10. In the case in which the wiring connected to the transparent electrode 20 disposed at the upper side of the base member 10 is formed to have a short length in the third direction of the base member 10, when the wiring connected to the transparent electrode 20 disposed at the lower side thereof is extended in the third direction, it should be formed to avoid an upper side wiring within an insulating layer to have a spatial limitation, thereby causing a complicated process. In addition, the length of the wiring becomes long, such that a resistance value is enlarged. As in above, a third wiring 34-3 of the wiring portions 34 is extended to be longer than the second wiring 34-2 of the wiring portions 34 in the third direction of the base member 10 and is bent and extended in the second direction of the base member 10, a fourth wiring 34-4 of the wiring portions 34 is extended to be longer than the third wiring 34-3 of the wiring portions 34 in the third direction of the base member 10 and is bent and extended in the second direction of the base member 10.

In addition, the wiring portions 34 may be extend in the third direction of the base member 10 and be bent and bent in a right angle in the second direction of the base member 10. Through-holes 36 are formed perpendicularly to the insulating layer to form the wirings electrically connected to exposed transparent electrodes 20, thereby having an easier process than the form in which the wiring is smoothly bent. The forms in which the wiring portions 34 are bent in the second direction of the base member 10 is not limited thereto but may be several forms, for example, a form in which the wiring portion are smoothly bent or a form in which the wiring portion are bent at a predetermined angle in the second direction.

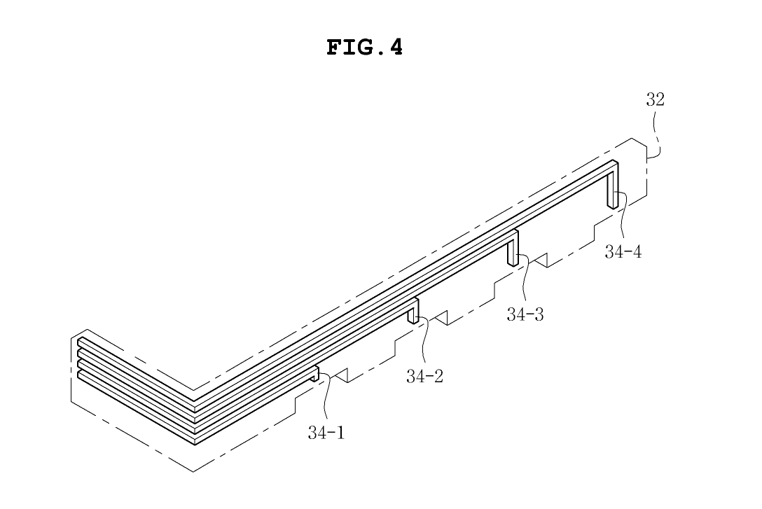

In addition, as shown in FIG. 4, the wiring portions 34 of the electrode wiring 30 are preferably formed on the same perpendicular plane. Herein, the ‘perpendicular plane’ indicates a plane perpendicular to the plane of the base member 10. When the wiring portions are extended in different lengths in the third direction of the base member 10 and are bent and extended in the second direction thereof, in the case in which they are formed on the same perpendicular plane, a multi-layer wiring is impregnated in the insulating portion 32 at one wiring width in the third direction of the base member 10, such that the width of the electrode wiring 30 becomes minimum. In the case in which the wirings are formed on different perpendicular planes to the base member 10 to be extended in the second direction of the base member 10, there are wiring intervals between the plurality of wirings in the first direction of the base member 10, such that the area of the non-display region (R2) is increased.

At this time, a material composing the wiring 34 is, preferably, silver (Ag). The silver (Ag) has a high electrical conductivity and excellent processability and mechanical characteristics.

The insulating portion 32 has the wiring portions 34 impregnated therein and are formed to be extended in the second direction of the base member 10. When the wiring of the conductive film is exposed in a manufacturing process of the touch panel, there is a risk of damage. Therefore, the wiring portion 34 is impregnated in the insulating portion, thereby making it possible to prevent the damage. In addition, the size of the insulating portion 32 encompassing the circumference of the wiring portion 34 is preferably small in impregnating the wiring portion 34 in the insulating layer 32. The reason is that the size of the display region (R1) sensing the touch is reduced as the size of the insulating portion 32 is larger.

In addition, although not shown, the shape of the insulating portion 32 may be a bar shape having a semi-circular or a semi-elliptical cross-section and extended in the second direction of the base member 10 in addition to a bar shape having a rectangular cross-section and extended in the second direction of the base member 10. The shape of the insulating portion 32 is not limited thereto but includes various shapes having various polygonal or circular cross-sections and extended in the second direction of the base member 10.

Meanwhile, the electrode wirings 30 are formed on an upper portion of one side or both sides of the transparent electrode 20, making it possible to reduce the length of the wiring portion 34 as compared to the case of forming the electrode wirings 30 on sides of the transparent electrodes 20 in connecting the wirings to the transparent electrode 20 and simplify the wiring form to simplify the manufacturing process of the electrode wiring.

An end of the electrode wiring 30 is positioned at one end of the base member 10 to be connected to flexible printed circuit (FPC). The electrode wiring 30 is bent to the inside of the base member 10 to be extended to a connecting portion with the FPC, and the end of the electrode wiring 30 has the wiring portion 34 exposed on one surface of the insulating portion 32 to be electrically connected to the FPC. Herein, the ‘inside’ indicates the second direction of the base member 10 toward the center the base member 10.

As the base member 10 of the conductive film, which is a transparent member, a glass substrate, a film substrate, a fiber substrate, and a paper substrate may be used. Among them, the film substrate may be made of polyethylene terephthalate (PET), polymethylemethacrylate (PMMA), polypropylene (PP), polyethylene (PE), polyethylenenaphatalenedicarboxylate (PEN), polycarbonate (PC), polyethersulfone (PES), polyimide (Pl), polyvinylalcohol (PVA), cyclic olefin copolymer (COC), stylene polymer, polyethylene, polypropylene, etc., and are not specifically limited.

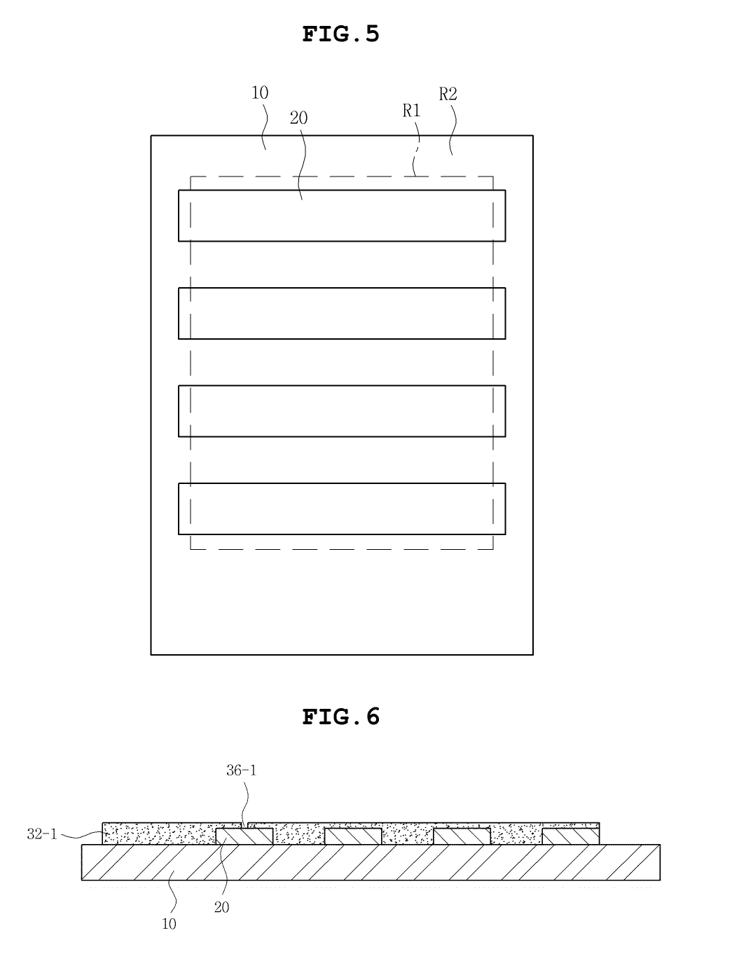

FIGS. 5 to 12 are views showing a manufacturing process of a conductive film according to a preferred embodiment of the present invention. Hereinafter, a manufacturing method of a conductive film according to a preferred embodiment of the present invention will be described with reference to FIGS. 5 to 12. The description of the portion overlapped with the above-mentioned description will be omitted.

As shown in FIG. 5, transparent electrodes 20 are first formed on a base member 10. N transparent electrodes 20 are formed on one surface of the base member 10, the N transparent electrode being arranged in a second direction of the base member 10, while being extended in a first direction of the base member 10, as shown in FIG. 5. The transparent electrode 20 is a portion sensing a change in capacitance when a user's hand touches a touch screen.

The transparent electrode 20 may be formed through a dry process or a wet process. As the wet process, there may be sputtering, evaporation, and the like, and as the dry process, there may be dip coating, spin coating, roll coating, spray coating, and the like.

As shown in FIGS. 6 to 11, electrode wirings 30 are formed.

First, a manufacturing process of a first wiring 34-1 connected to the transparent electrode disposed at the lowermost side of the base member 10 will be described. As shown in FIG. 6, a first insulating layer 32-1 extended in the second direction of the base member 10 is stacked on an upper portion of one end or both ends of the transparent electrodes 20.

Next, a through-hole 36 is formed in the insulating layer so that one transparent electrode 20 of the N transparent electrode 20 is exposed. Since the wirings connected to the transparent electrode 20 are formed in the order of the transparent electrodes 20 arranged from a lower side of the base member 10 to an upper side thereof, a first through-hole 36-1 is first formed so that the transparent electrode 20 disposed at the lowermost side of the base member 10 among the N transparent electrodes is exposed. The through-hole may have any one of a rectangular shape, a diamond shape, and a circular shape. However, the shape of the through-hole is not limited thereto and may be several shapes. The size of the through-hole is preferably formed to be larger than that of a nozzle in order to easily filling a conductive paste by an inkjet printing method. The through-hole may be formed by laser or drilling.

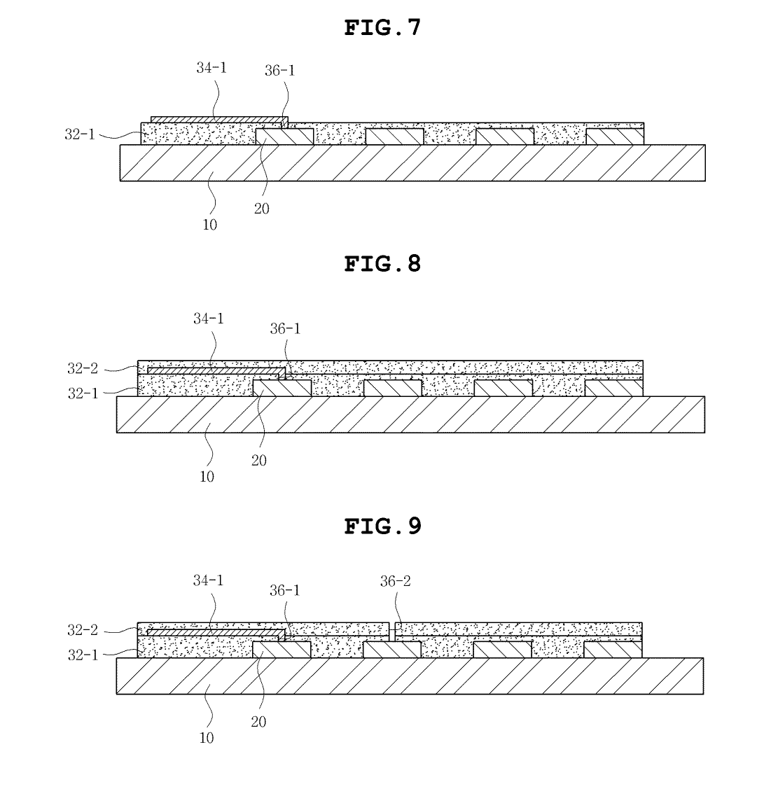

As shown in FIG. 7, a first wiring 34-1 extended in the second direction of the base member 10 is formed on an upper portion of the first insulating layer 32-1 to be electrically connected to the exposed transparent electrode 20.

At this time, a process forming the wiring extended in the second direction of the base member 10 on the upper portion of the first insulating layer 32-1 to be electrically connected to the exposed transparent electrode 20 includes: (D-1) filling the through-holes 36 with the conductive paste; and (D-2) forming metal patterns electrically connected to the conductive paste and extended in the second direction of the base member 10.

The through-hole 36 may be filled with the conductive paste using the inkjet printing method. The through-hole 36 is filled with the conductive paste, such that the first wiring is electrically connected to the transparent electrode 20 exposed by the through-hole 36. The first wiring and the exposed transparent electrode may also be electrically connected to each other through metal plating without filling the through-hole 36 with the conductive paste.

The metal patterns are formed on the upper portion of the insulating layer, and may be formed by any one of a silk screen method, a gravure printing method or an inkjet printing method.

Next, a second wiring 34-2 connected to the upper side transparent electrode 20 adjacent to the lowermost transparent electrode 20 of the base member 10 is formed. As shown in FIG. 8, a second insulating layer 32-2 is stacked on the upper portion of the first insulating layer 32-1 on which the metal pattern is formed. The second insulating layer 32-2 is preferably formed at a thin thickness so that a wiring interval in a third direction of the base member 10 is narrowly formed.

As shown in FIG. 9, a second through-hole is formed at a position corresponding to the upper side transparent electrode 20 adjacent to the lowermost transparent electrode 20 of the base member 10.

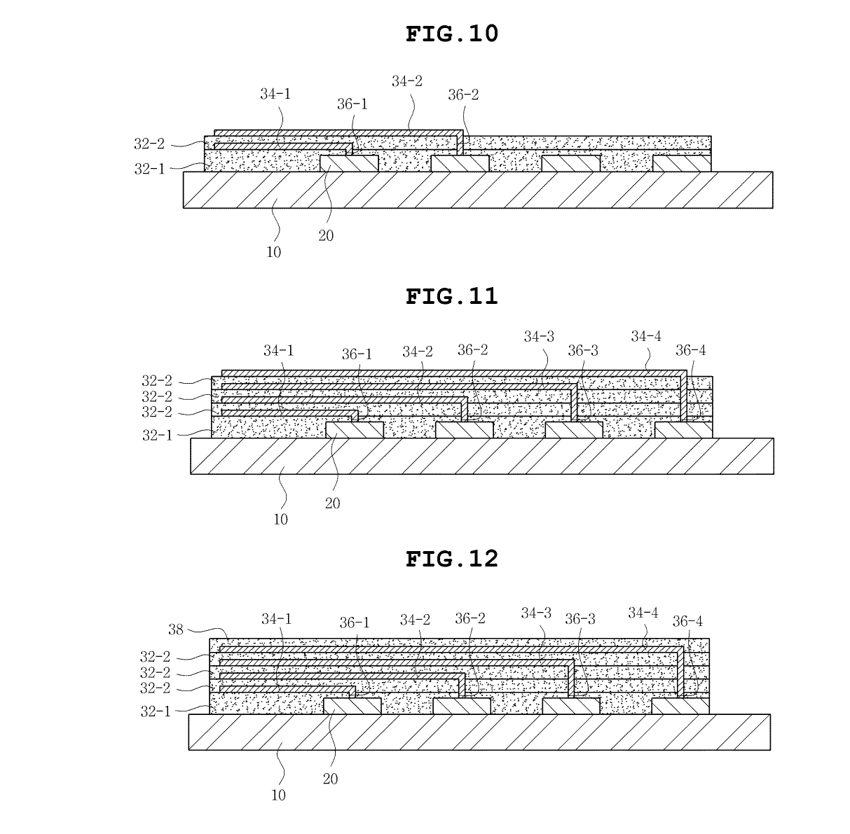

As in above description, as shown in FIG. 10, a wiring extended in the second direction of the base member 10 is formed on an upper portion of the second insulating layer 32-2 to be electrically connected to the transparent electrode 20.

As such, steps of stacking the insulating layer, forming the through-hole and forming the wiring are repeated, thereby impregnating a third wiring 34-3 and a fourth wiring 34-3 each correspondingly connected to one end or both ends of the transparent electrode 20, as shown in FIG. 11. At this time, the third through-hole 36-3 is first formed, the wiring is formed, the insulating layer is stack, the fourth through-hole 36-4 corresponding to the upper transparent electrode 20 adjacent to the transparent electrode 20 corresponding to the position at which the to third through-hole is formed is formed, the wiring is formed, the insulating is stack, in the order of the lower side of the base member 10 to the upper side thereof.

A plurality of wirings each correspondingly connected to one end or both ends of the N transparent electrodes by repeating the above process configures a wiring portion 34 and a plurality of insulating layer are stacked to configure an insulating portion 32 of the conductive film.

At this time, as shown in FIG. 12, a protective layer 38 covering the wire formed on a top portion of the insulating layer may be formed. The protective layer 38 covering the wiring may be made of an insulating material, which may be an organic based insulating material or an inorganic based insulating material. The protective layer 38 is formed, thereby making it possible to solve a problem that the wiring is exposed to be damaged during a manufacturing process.

In addition, the through-holes 36 may be sequentially formed in a straight line in repeating the step of forming the through-hole 36. The metal patterns electrically connected to the transparent electrode 20 by the through-holes sequentially formed in a straight line and extended in the second direction of the base member 10 are formed, thereby making it possible to form the plurality of wirings on the same perpendicular plane to the base member 10.

The electrode wiring 30 may also be formed using different methods from the manufacturing method described above with reference to FIGS. 5 to 11. A plurality of wirings are formed on the insulating layers extended in the second direction of the base member 10 using a silk screen method, a gravure printing method an inkjet printing method, or the like. Then, the insulating layer is stacked on an upper portion of the insulating layer on which the wiring is formed to form the electrode wiring 30 having the wiring impregnated in the insulating layer.

Next, the electrode wiring 30 is bond to upper portions of one side or both sides of the transparent electrode 20 to be correspondingly connected to the transparent electrode 20. At this time, a conductive adhesive is used at a connecting portion between the transparent electrode 20 and the electrode wiring 20 in order to conduct electricity.

The conductive film according to the preferred embodiment of the present invention is configured of the insulating portions and the wiring portions and is formed in a three-dimensional shape rather than a plane on the base member. The wiring portions including the plurality of wirings are formed on the plane perpendicular to the base member in the insulating portion to reduce the area occupied by the electrode wirings, thereby making it possible to reduce the size of the non-display region.

According to the preferred embodiment of the present invention, the wiring portions are extended to be shorter in the third direction of the base member according to the order thereof connected to the transparent electrodes formed from the lower side of the base member to the upper side thereof and are bent and extended in the second direction of the base member, thereby making it possible to the manufacturing process of the electrode wirings in forming the electrode wirings in the three-dimensional shape on the base member and effectively reduce the area of the occupied by the electrode wirings.

According to the preferred embodiment of the present invention, the wiring portions are formed on the same perpendicular plane to the base member to form the plurality of wirings as the multi-layer at one wiring width, thereby minimizing the area of the occupied by the electrode wirings.

Although the preferred embodiments of the present invention have been disclosed for illustrative purposes, they are for specifically explaining the present invention and thus a conductive film and a manufacturing method thereof according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A conductive film, comprising:
a base member;
N transparent electrodes formed on one surface of the base member, the N transparent electrodes being arranged in a second direction of the base member, while being extended in a first direction of the base member; and
electrode wirings each correspondingly connected to one end or both ends of the N transparent electrodes and including wiring portions configured of a plurality of wirings extended in a third direction of the base member and bent and extended in the second direction of the base member and insulating portions having the wiring portions impregnated therein and formed on an upper surface of one side or both sides of the transparent electrode.

2. The conductive film as set forth in claim 1, wherein the wiring portions are extended to be shorter in a third direction of the base member according to the order thereof connected to the transparent electrodes formed from a lower side of the base member to an upper side thereof and are bent and extended in the second direction of the base member.

3. The conductive film as set forth in claim 1, wherein the wiring portions are formed on the same perpendicular plane to the base member.

4. The conductive film as set forth in claim 1, wherein the transparent electrode is made of a conductive polymer.

5. The conductive film as set forth in claim 4, wherein the conductive polymer is any one of polythiophene-based compound, polypyrrole-based compound, polyphenylene-based compound, polyaniline-based compound or polyacetylene-based compound.

6. The conductive film as set forth in claim 1, wherein the electrode wiring is made of silver (Ag).

7. A manufacturing method of a conductive film, comprising:
(A) forming N transparent electrodes on a base member, the N transparent electrode being arranged in a second direction of the base member, while being extended in a first direction of the base member;
(B) stacking insulating layers extended in the second direction of the base member on an upper portion of one end or both ends of the transparent electrodes;
(C) forming through-holes in the insulating layers so that one of the N transparent electrodes is exposed; and
(D) forming wirings extended in the second direction of the base member on upper portions of the insulating layers to be electrically connected to the exposed transparent electrode,
wherein step (B), step (C), and step (D) are repetitively performed and the through-holes are sequentially formed from a lower side of the base member to an upper side thereof.

8. The manufacturing method of a conductive film as set forth in claim 7, further comprising, after repetitively performing step (B), step (C), and step (D), (E) forming a protective layer covering the wiring formed on a top portion of the insulating layer.

9. The manufacturing method of a conductive film as set forth in claim 7, wherein in repetitively performing step (B), the through-holes are sequentially formed in a straight line.

10. The manufacturing method of a conductive film as set forth in claim 7, wherein step (D) includes: (D-1) filling the through-holes with the conductive paste; and (D-2) forming metal patterns electrically connected to the conductive paste and extended in the second direction of the base member.

11. The manufacturing method of a conductive film as set forth in claim 10, wherein the metal patterns are formed using any one of a silk screen method, a gravure printing method or an inkjet printing method.
